(19) United States
(12) Patent Application Publication
(10) Pub. No.: US 2013/0117486 A1
(43) Pub. Date: May 9, 2013

(54) I/O VIRTUALIZATION VIA A CONVERGED TRANSPORT AND RELATED TECHNOLOGY

(71) Applicant: David A. Daniel, Scottsdale, AZ (US)

(72) Inventor: David A. Daniel, Scottsdale, AZ (US)

(21) Appl. No.: 13/669,177

(22) Filed: Nov. 5, 2012

Related U.S. Application Data
(60) Provisional application No. 61/556,078, filed on Nov. 4, 2011.
(60) Provisional application No. 61/560,401, filed on Nov. 16, 2011.

(51) Int. Cl. G06F 13/40

(52) U.S. Cl. CPC G06F 13/40
USPC 710/300

(57) ABSTRACT

The invention is directed to I/O Virtualization via a converged transport, as well as technology including low latency virtualization for blade servers and multi-host hierarchies for virtualization networks. A virtualization pipe bridge is also disclosed, as well as a virtual desktop accelerator, and a memory mapped thin client.

### CLAIM OF PRIORITY

This application claims priority of U.S. Provisional Patent Application Ser. No. 61/556,078 entitled I/O Virtualization via a Converged Transport and Related Technology filed Nov. 4, 2011 and U.S. Provisional Patent Application Ser. No. 61/560,401 entitled Virtual Desktop Accelerator, Remote Virtualized Desktop Accelerator Pool, and Memory Mapped Thin Client filed Nov. 16, 2011.

### BACKGROUND OF THE TECHNOLOGY

i-PCI—A hardware/software system and method that collectively enables virtualization of the host bus computer's native I/O system architecture via the Internet, LANs, WANs, and WPANs is described in U.S. Pat. No. 7,734,859, the teaching of which are included herein in its entirety. The system described therein, designated “i-PCI”, achieves technical advantages as a hardware/software system and method that collectively enables virtualization of the host computer's native I/O system architecture via the Internet, LANs, WANs, and WPANs.

This system allows devices native to the host computer native I/O system architecture—including bridges, I/O controllers, and a large variety of general purpose and specialty I/O cards—to be located remotely from the host computer, yet appear to the host system and host system software as native system memory or I/O address mapped resources. The end result is a host computer system with unprecedented reach and flexibility through utilization of LANs, WANs, WPANs and the Internet, as shown in FIG. 1.

A solution for handling Quality of Service (QOS) application compatibility in extended computer systems via a class system is described in U.S. patent application Ser. 12/587,788, the teachings of which are included herein by reference in its entirely. The system described therein describes a framework based on definition of classes for performance categorization and management of application compatibility and user experience.

PCI Express QoS/TCs/VCs and Transaction Ordering —PCI Express provides the capability of routing packets from different applications through the PCI Express interconnects according to different priorities and with deterministic latency and bandwidth allocation. PCI Express utilizes Traffic Classes (TCs) and Virtual Channels (VCs) to implement Quality of Service (QoS). QoS for PCIe is application-software specific such that a TC value is assigned to each transaction which defines the priority for that transaction as it traverses the links.

TC is a Transaction Layer Packet (TLP) header field that is assigned a value of 0-7 according to application and system software, with 0 being the “best effort general purpose” class and 7 having the highest performance/priority.

Virtual Channels (VCs) are the physical transmit and receive buffer pairs that provide a means to support multiple independent logical data flows over a physical link. A link may implement up to 8 virtual buffer pairs to form the virtual channels.

The application software then assigns the TC-to-VC mapping to optimize performance. An illustration showing an example of how TCs are mapped to VCs for a given link is shown in FIG. 2.

PCI Express imposes transaction ordering rules for transactions crossing the links at the same time, to ensure completion of transactions are deterministic and in sequence; to avoid deadlock conditions; to maintain compatibility with legacy PCI; and to maximize performance and throughput by managing read/write ordering and read latency. These transaction ordering rules are enforced per TC and accordingly per the corresponding VC.

New Ethernet Application Domains—Recent industry development efforts seek to adapt and push Ethernet as the “universal network” solution, not just for office, datacenter, and Internet applications, but for production facilities, safety-critical, mission-critical, aircraft, spacecraft, and automobile applications. To date, perhaps 30-40 different approaches and schemes have been proposed, most notably the following two:

Time Triggered Ethernet—“Time-Triggered Ethernet” (TTE) is defined by new SAE standard AS6802, also referred to as “Deterministic Ethernet”, expands on the standard Ethernet IEEE 802.3. Standard Ethernet, a “best effort” protocol, does not lend itself to tasks with deterministic, time-critical, or safety related requirements. TTE addresses these short comings and provides support for low latency deterministic applications, such as hard real-time command and controls, as well as loss-less applications. The benefit is that a complete mix of traffic including audio, video, storage, and critical controls may all utilize the same “converged transport” effectively.

Converged Enhanced Ethernet (CEE) and Data Center Bridging —Efforts to provide enhancements to Ethernet 802.1 bridge (MAC) specifications are focused on supporting deployment of a “converged network” where all applications can be run over a single physical infrastructure. The enhancements provide Congestion Notification (CN), defined by IEEE802.1Qau, which will support upper layer protocols that don't already have congestion control mechanisms as well as provide quicker responding congestion management that currently provided by protocols such as TCP. Priority-based Flow Control (PFC), defined by IEEE802.1Qbb, provides a link-level mechanism to ensure zero loss due to congestion, for loss-less applications. Enhanced Transmission Selection (ETS), defined by IEEE 802.1Qaz, provides a means for assigning bandwidth to various traffic classes.

### BRIEF DESCRIPTION OF FIGURES

FIG. 1 shows the end result of a host computer system with unprecedented reach and flexibility through utilization of LANs, WANs, WPANs and the Internet;

FIG. 2 shows an illustration showing an example of how TCs are mapped to VCs for a given link;

FIG. 3 shows a converged ethernet Host Bus Adapter block diagram of the resultant device;

FIG. 4 shows a converged Transport Mapper, providing an illustrative example of the internal mapping table forming the basis of the PCIe TCs & VCs to Converged Transport Mapper block;

FIG. 5 shows the front view of a typical open blade chassis with multiple blades installed;

FIG. 6 shows the rear view and the locations of the I/O bays with unspecified I/O modules installed;

FIG. 7 depicts a block diagram of the overall low-latency solution that allows blade access to standard PCI Express Adapter functions via memory-mapped I/O virtualization;

FIG. 8 shows the major functional blocks of a Low-Latency High Speed Adapter (HAC) card;

FIG. 9 shows the major functional blocks of a Low-Latency I/O 10 Gbps Switch Module;

FIG. 10 shows Virtualization Solutions, showing how the Multi-Host I/O Hierarchy Virtualization via Networks fits into the virtualization landscape;

FIG. 11 shows PCI Express Topology extending the topology by adding an entire virtual I/O hierarchy via virtualization;

FIG. 12 shows PCI Express Topology with Virtual I/O Hierarchy;

FIG. 13 shows software components including the vPCI Device Interface, vResource Manager, vConfig-Space Manager .vMemoryMapped I/O Manager and vNetwork Manager;

FIG. 14 shows a Hypervisor Implementation;

FIG. 15 shows a block diagram of the Host Bus Adapter;

FIG. 16 shows a block diagram of the Remote Bus Adapter;

FIG. 17 shows a PIPE Interface;

FIG. 18 shows an improved Host Bus Adapter;

FIG. 19 shows an improved Remote Bus Adapter;

FIG. 20 shows a PLC Host Bus Adapter including a block diagram of the resultant apparatus;

FIG. 21 shows a simplified example Mapper;

FIG. 22 shows an OSI model, illustrating the OSI model layers and the TCP/IP corresponding protocols;

FIG. 23 shows a general high-level block diagram for a TOE;

FIG. 24 shows a Two-Part module solution;

FIG. 25 shows the front view of a typical open blade chassis with multiple blades installed;

FIG. 26 shows the rear view and the locations of the I/O bays with unspecified I/O modules installed;

FIG. 27 shows a diagram of the PCoIP solution using a conventional (non-blade) server;

FIG. 28 depicts a block diagram of the overall high-performance Virtual Desktop Accelerator solution;

FIG. 29 shows the major functional blocks of a Low-Latency High Speed Adapter (HAC) card;

FIG. 30 shows the major functional blocks of a Low-Latency I/O 10 Gbps Switch Module;

FIG. 31 shows a given virtual hierarchy as a partial software construct or emulation, with the physical I/O located remote, connected to the host via the host system's Network Interface Card (NIC) and a LAN;

FIG. 32 shows a diagram of the PCoIP solution using a conventional (non-blade) server;

FIG. 33 shows an illustration of one aspect of the invention;

FIG. 34 shows a diagram of the PCoIP solution using a conventional (non-blade) server; and

FIG. 35 shows a block diagram of the overall high performance low-latency memory-mapped thin client solution.

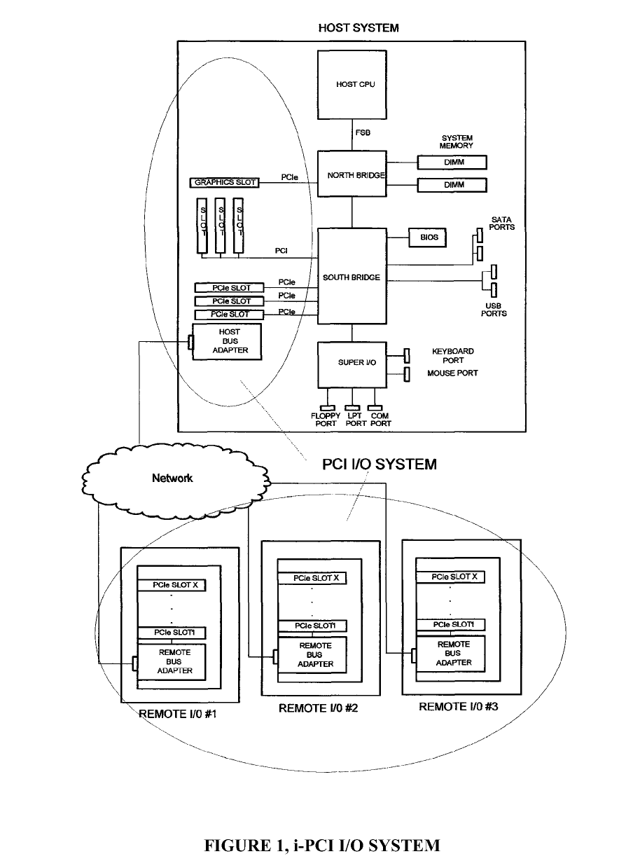

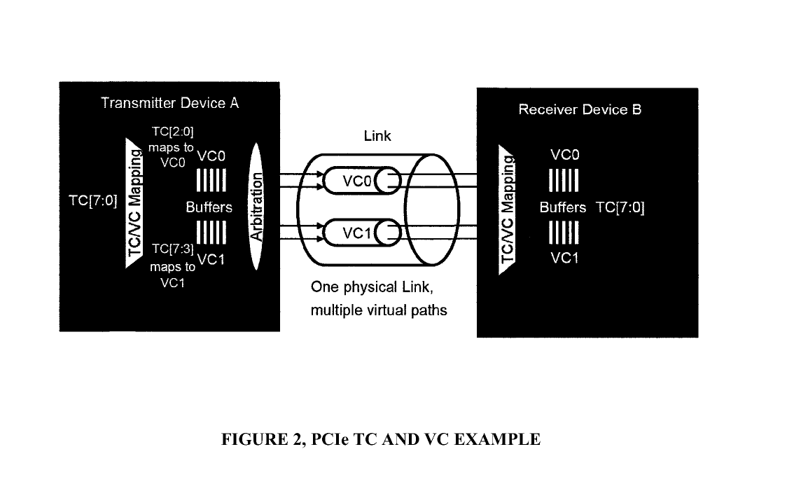

### DESCRIPTION OF MULTIPLE ASPECTS OF THE INVENTION

### I. I/O Virtualization Via a Converged Transport

One aspect of the invention is an apparatus and method for mapping PCIe TCs and VCs to a converged transport where Time Triggered Ethernet and Converged Enhanced Ethernet are the preferred transports. This aspect of the invention advantageously interfaces to a Class System Handler as defined in U.S. patent application Ser. 12/587,788 to provide a superior mapping than otherwise possible.

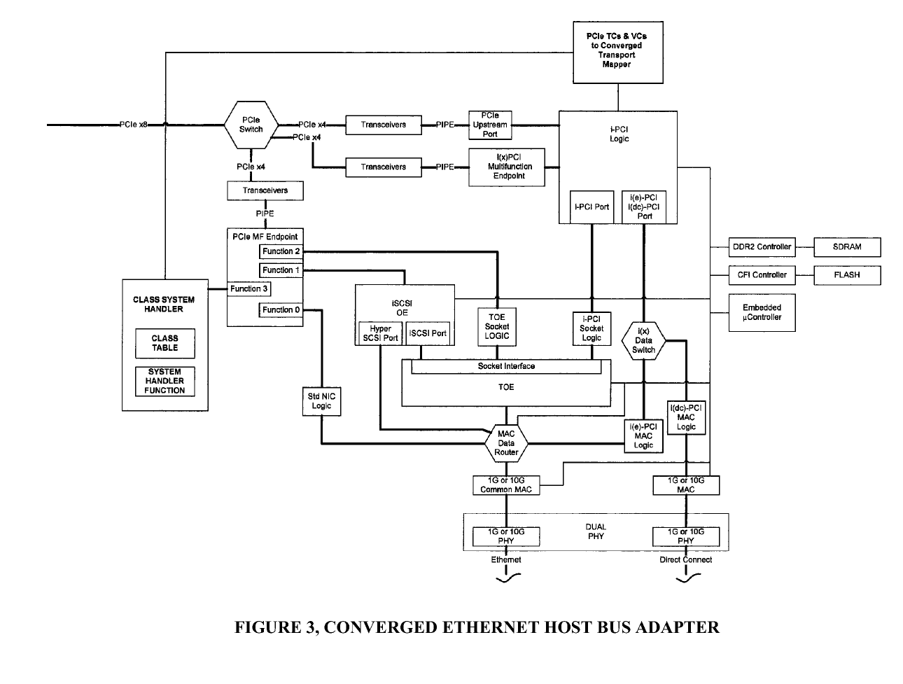

This aspect of the invention implements a Class System Handler, in one preferred implementation, as a PCIe function and couples it to a PCIe TCs and VCs to Converged Transport Mapper, “Mapper”. FIG. 3, Converged Ethernet Host Bus Adapter shows a block diagram of the resultant device.

The Class System Handler block is described by U.S. patent application Ser. 12/587,788.

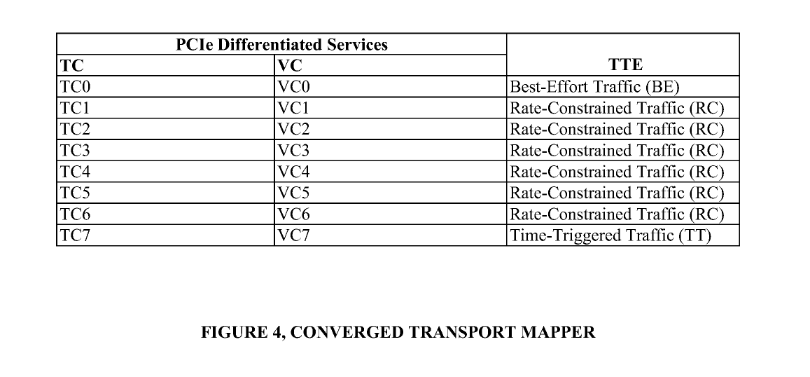

FIG. 4, Converged Transport Mapper, provides an illustrative example of the internal mapping table forming the basis of the PCIe TCs & VCs to Converged Transport Mapper block. This Mapper block is coupled to the i-PCI Logic block enabling effective referencing and processing of ingress and egress PCIe TLPs.

FIG. 4 is a simplified example Mapper and is meant to be illustrative of the concept. The tight coupling of the Mapper and the Class Table contained within the Class System Handler ensures that QoS information associated with the Mapper is readily available for use in classification such that application performance is predictable and manageable.

The end result is an effective I/O Virtualization via a Converged Transport.

### II. Low-Latency Virtualization Solution for Blade Servers

Another aspect of the invention is a solution for blade server I/O expansion, where the chassis backplane does not route PCI or PCI Express to the I/O bays. The invention is a unique flexible expansion concept that utilizes virtualization of the PCI I/O system of the individual bade servers, via 10 Gigabit Attachment Unit Interface (XAUI) routing across the backplane high-speed fabric of a blade server chassis. The invention leverages the i-PCI protocol as the virtualization protocol.

A problem with certain blade server architectures is PCI Express is not easily accessible, thus expansion is awkward, difficult, or costly. In such an architecture the chassis backplane does not route PCI or PCI Express to the I/O module bays. An example of this type of architecture is the open blade server platforms supported by the Blade.org developer community: http://www.blade.org/aboutblade.cfm

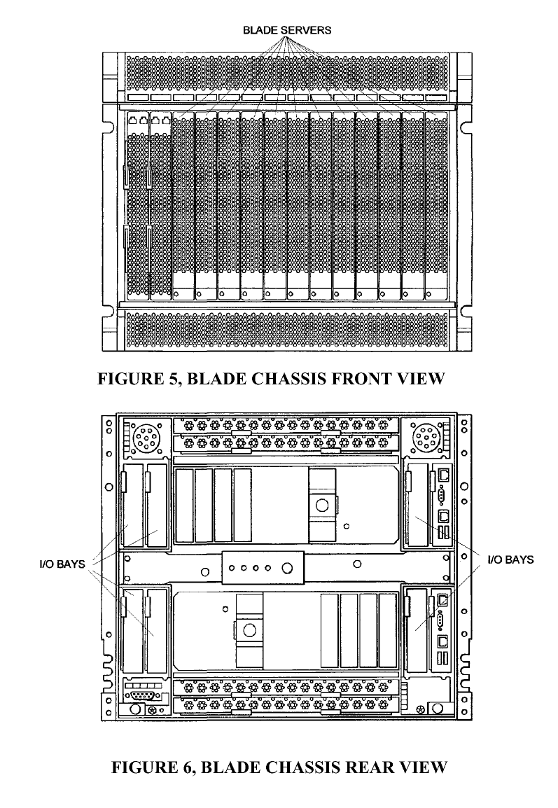

FIG. 5 shows the front view of a typical open blade chassis with multiple blades installed. Each blade is plugged into a backplane that routes 1 Gbps Ethernet across a standard fabric and optionally Fibre Channel, Infiniband, or 10 Gbs Ethernet across a high-speed fabric that interconnects the blade slots and the I/O bays.

FIG. 6 shows the rear view and the locations of the I/O bays with unspecified I/O modules installed. A primary advantage with blades over traditional rack mount servers is they allow very high-density installations. They are also optimized for networking and Storage Area Network (SAN) interfacing. However, there is a drawback inherent with blade architectures such as that supported by the blade.org community. Even though the blades themselves are PCI-based architectures, the chassis back plane does not route PCI or PCI Express to the I/O module bays. Since PCI and PCI Express are not routed on the back plane, the only way to add standard PCI functions is via an expansion unit that takes up a valuable blade slot. The expansion unit in this case adds only two card slots and there is no provision for standard PCI Express adapters. It is an inflexible expansion, as it is physically connected and dedicated to a single blade.

One aspect of the invention is a unique expansion concept that utilizes virtualization of the PCI I/O system of the individual bade servers, via 10 Gigabit Attachment Unit Interface (XAUI) routing across the backplane high-speed fabric of a blade server chassis. The invention leverages i-PCI as the virtualization protocol.

A major contributor to the latency in virtualization solutions that utilize 802.3an (10 GBASE-T) is the introduced latency associated with the error correcting “Low-Density Parity-Check Code” (LDPC). LDPC is used to get the large amounts of data across the limited bandwidth of the relatively noisy copper twisted pair CAT 6 cable. LDPC requires a block of data to be read into the transmitter PHY where the LPDC is performed and then sent across the cable. The reverse happens on the receiving side. The total end-to-end latency associated with the coding is specified as 2.6 microseconds. This introduced latency can be a serious barrier to deploying latency sensitive applications via virtualization, requiring special latency and timeout mitigation techniques that add complexity to the virtualization system.

With the invention, the latency problem can be avoided across the backplane. Instead of running 10 GBASE-T across the backplane as disclosed in U.S. patent application Ser. 12/587,780, XAUI is run across the backplane, to a unique Low Latency I/O 10 Gbps Switch Module with a XAUI interface to the backplane. These are not concepts envisioned by the Open Blade standard, so it is not obvious based on the current state of the art. Since there is no PHY associated with this link across the backplane, the associated latency is advantageously eliminated.

The low latency solution may optionally be extended external to the Blade Chassis to the Remote Bus Adapter and Expansion Chassis containing PCIe adapter cards, utilizing 802.3ak twin-axial or 802.3ae fiber optic links (typically 10 GBASE-SR or LR) that avoid the LDPC associated with 10 GBASE-T.

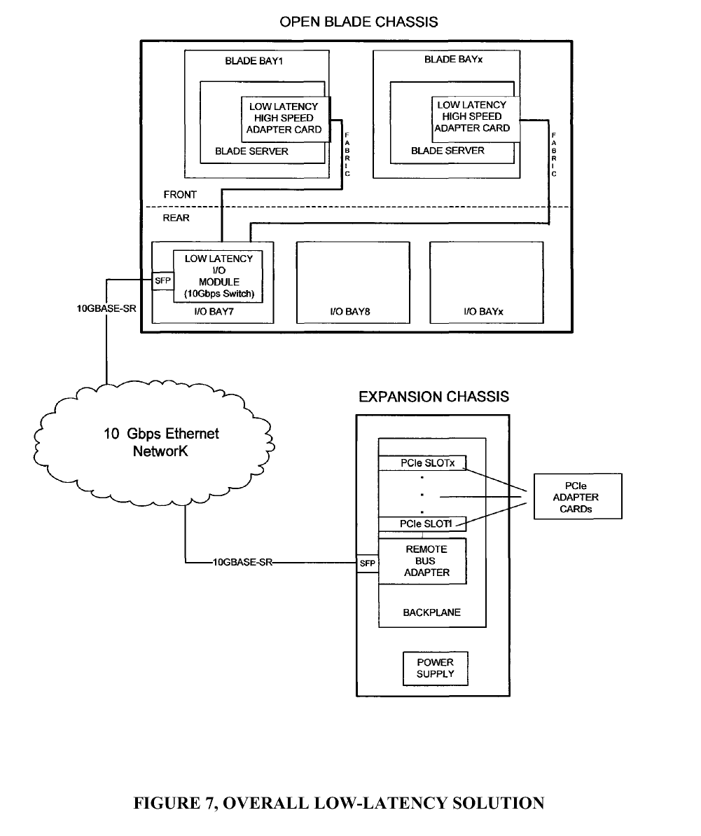

FIG. 7 depicts a block diagram of the overall low-latency solution that allows blade access to standard PCI Express Adapter functions via memory-mapped I/O virtualization.

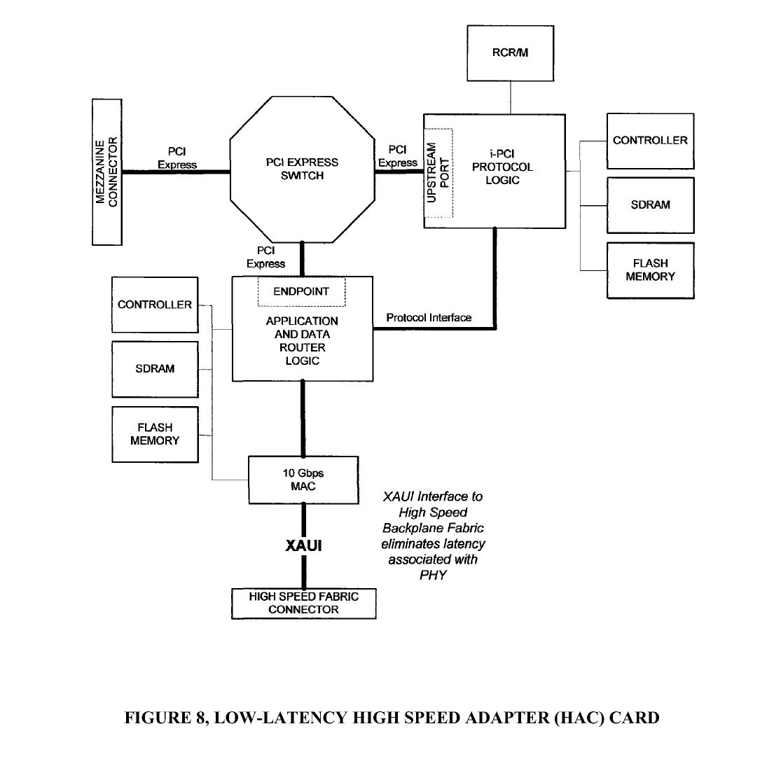

FIG. 8 shows the major functional blocks of a Low-Latency High Speed Adapter (HAC) card.

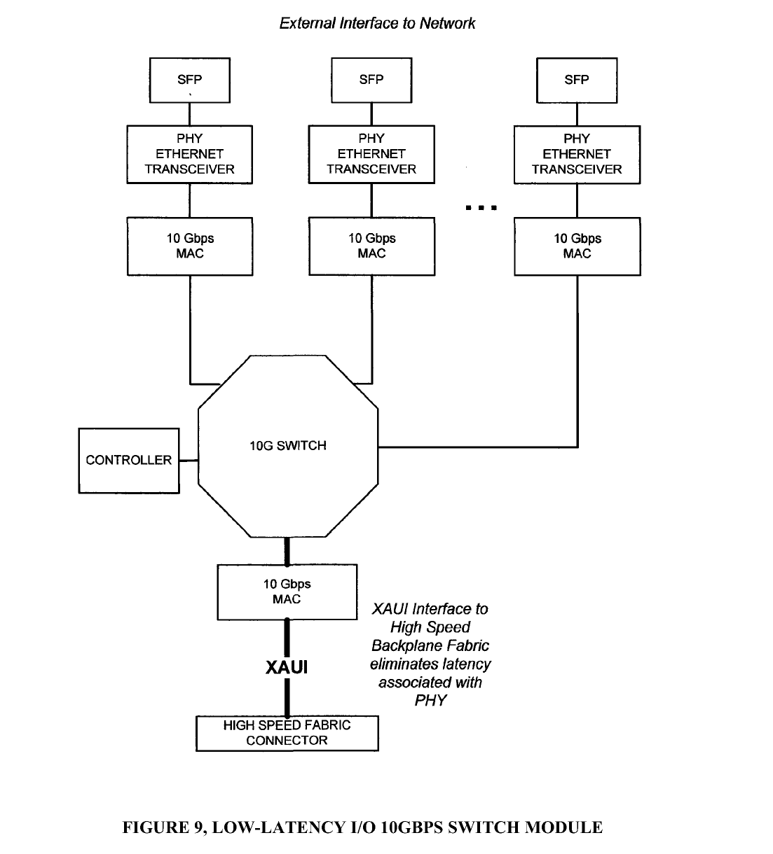

FIG. 9 shows the major functional blocks of a Low-Latency I/O 10 Gbps Switch Module.

A mechanism that collective enables low latency virtualization of the native I/O subsystem of a blade server comprising:

A low latency high-speed adapter card, adapted to the blade server native I/O standard, configured to encapsulate/un-encapsulate data, and adapted via a PHY-less interface to a high speed blade chassis backplane fabric configured to route XAUI.

A low latency switch module configured to adapt, via a PHY-less interface, the high speed blade chassis backplane fabric routing XAUI, to an external network.

A Remote Bus Adapter configured to encapsulate/un-encapsulate data and adapt the external network to a passive backplane routing the same I/O standard as the blade server native I/O standard.

A passive backplane configured to host any number of I/O adapter cards, adapting the blade server native I/O standard to any number of I/O functions.

### III. Multi-Host I/O Hierarchy Virtualization Via Networks

One aspect of the invention is an apparatus and method for creating a virtual PCI Express (PCIe) I/O hierarchy such that I/O resources may be shared between multiple hosts (Host-to-Host).

In computing terminology, virtualization refers to techniques for concealing the physical characteristics, location, and distribution of computing resources from the computer systems and applications that have access to them.

A I/O hierarchy, in terms of PCIe, is a fabric of various devices—and links interconnecting the various devices—that are all associated with a Root Complex. An I/O hierarchy consists of a single instance of a PCI Express fabric. An I/O hierarchy is composed of a Root Complex, switches, bridges, and Endpoint devices as required. An I/O hierarchy is implemented using physical devices that employ state machines, logic, and bus transceivers with the various components interconnected via circuit traces and/or cables.

“Multi-Host I/O Hierarchy Virtualization via Networks”, hereafter referred to as the “invention”, falls in the same general computing realm as iSCSI, which is a virtualization solution for networked storage applications. iSCSI defines a transport for the SCSI bus via TCP/IP and existing interconnected LAN infrastructure.

There are two main categories of virtualization: 1) Computing Machine Virtualization 2) Resource Virtualization.

Computing Machine Virtualization—Computing machine virtualization involves definition and virtualization of multiple operating system (OS) instances and application stacks into partitions within a host system. A thin layer of system software, referred to as the Virtual Machine Monitor (VMM) executes at the hardware level. The OS instances and stacks run on top of the VMM. Computer hardware resources are virtualized by the VMM and assigned to the partitions. Thus, multiple virtual machines may be created to operate resident on a single host.

Resource Virtualization—Resource virtualization refers to the abstraction of computer peripheral functions, such as those typically implemented on adapter cards or cabled attachments. There are two main types of Resource virtualization 1) Storage Virtualization: 2) Memory-Mapped I/O Virtualization. Of the two categories of virtualization, storage virtualization is currently the most prevalent.

Storage Virtualization—Storage virtualization involves the abstraction and aggregation of multiple physical storage components into logical storage pools that can then be allocated as needed to computing machines. Storage virtualization falls into two categories 1) File-level Virtualization 2) Block-level Virtualization. In file-level virtualization, high-level file-based access is implemented. Network-attached Storage (NAS) using file-based protocols such as SMB and NFS is the prominent example.

In block-level virtualization, low-level data block access is implemented. In block-level virtualization, the storage devices appear to the computing machine as if it were locally attached. Storage Attached Network (SAN) is an example of this technical approach. SAN solutions that use block-based protocols include iSCSI (SCSI over TCP/IP), HyperSCSI (SCSI over Ethernet), Fiber Channel-over-Ethernet Protocol (FCoE), and ATA-over-Ethernet (AoE).

Memory-mapped I/O Virtualization—Memory-mapped I/O virtualization is an emerging area in the field of virtualization. PCI Express I/O virtualization, as defined by the PCI-SIG enables local I/O resource (i.e. PCI Express Endpoints) sharing among virtual machine instances.

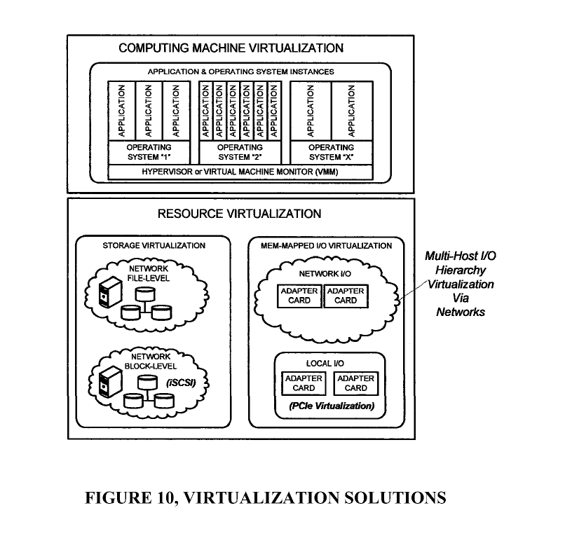

The invention is positioned in the resource virtualization category as a memory-mapped I/O virtualization solution. Whereas PCI Express I/O virtualization is focused on local virtualization of the I/O, the invention is focused on networked virtualization of I/O. Whereas iSCSI is focused on networked block level storage virtualization, the invention is focused on networked memory-mapped I/O virtualization. FIG. 10, Virtualization Solutions, shows how the invention, Multi-Host I/O Hierarchy Virtualization via Networks fits into the virtualization landscape.

One aspect of the invention provides the means by which individual PCI Devices associated with a remote host, accessible via a network, may be added such that they appear within another host's existing I/O hierarchy. There are issues in a given implementation with adding a device into a host's existing hierarchy, as the introduction has the potential to negatively impact system stability due to complications associated with interactions with the Root Complex.

The invention utilizes the i-PCI protocol (specifically “Soft i-PCI”) with 1 Gbps-10 Gbps or greater network connectivity via the host systems existing LAN adapters (NICs) along with additional unique software to form a hierarchy virtualization solution.

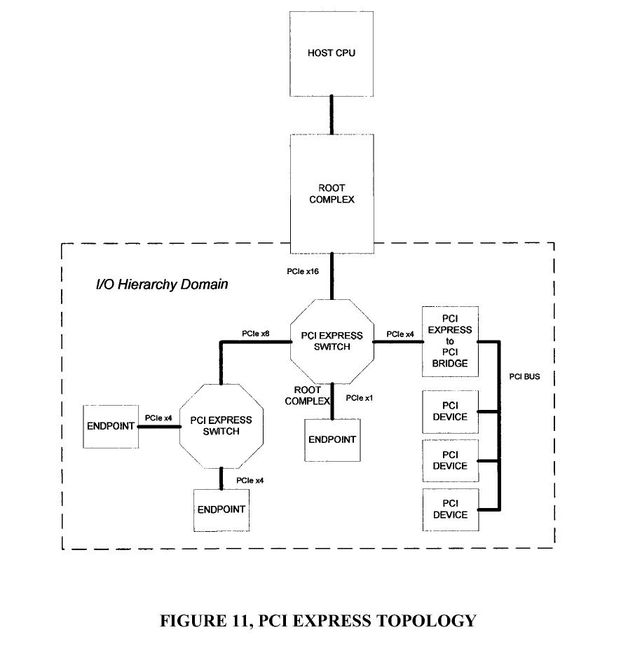

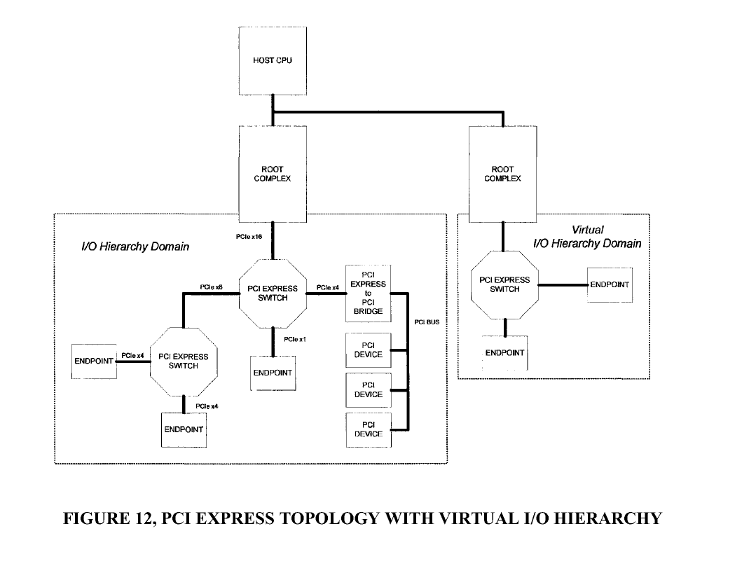

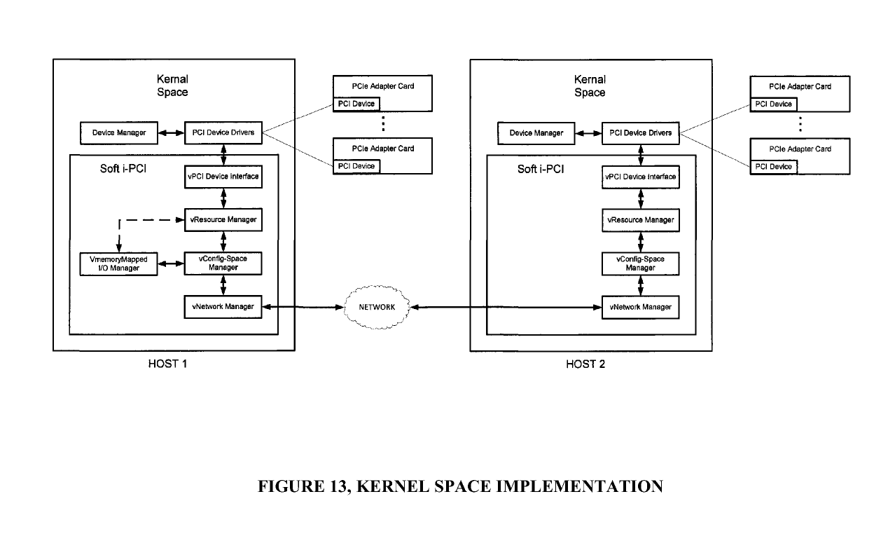

The invention works within a host's PCI Express topology, (see FIG. 11, PCI Express Topology) extending the topology by adding an entire virtual I/O hierarchy via virtualization (see FIG. 12, PCI Express Topology with Virtual I/O Hierarchy). It allows the creation of a new hierarchy on a host system, where the new hierarchy consists of a fabric populated with PCI devices that are actually located on a separate remote host system accessible via a network. The PCI devices or functions may themselves be virtual devices or virtual functions as defined by the PCI Express standard. Thus, the invention works in conjunction with and complements PCI Express I/O virtualization.

The invention consists of a system (apparatus) consisting of several “components” collectively working together between Host 1 and Host 2, where Host 1 is defined as the computer system requesting PCI devices and Host 2 is defined as the remotely located computer system connected via the network.

The invention simulates the initialization procedure of the I/O hierarchy domain dealing with discovery, initialization and emulation of PCI I/O hierarchy on the local device, which is available to it remotely over a network. Thus Host 1 is also configured with the I/O Hierarchy domain associated with Host 2. The discovery of PCI resources over the network can be achieved either by a dynamic discovery process or with the statically set pre-configured information.

Two implementations, Kernel Space and Hypervisor, are described in the following paragraphs.

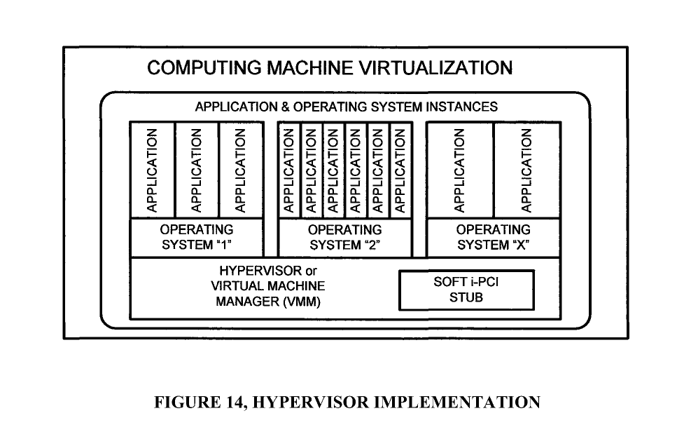

Kernel Space Implementation—As shown in FIG. 13, software components of the invention include the vPCI Device Interface, vResource Manager, vConfig-Space Manager .vMemoryMapped I/O Manager and vNetwork Manager (where V stands for virtual interfaces for remotely connected devices).

vPCI Device Interface:—The vPCI Device Interface (vPDI) directly interacts with the kernel. The vPDI also acts as an entry point for Soft-iPCI during the operating system boot-up process in order to initialize the virtual PCI I/O hierarchy as well as it handles the virtual PCI device operations. vPDI has multiple components which work in tandem with each other as well as with the existing device manager of the kernel on Host-1 in order to handle the operations on the virtually appearing root port, PCI Bus and the endpoints (PCI devices). During the boot-up process, vPDI initiates the handshaking and PCI resource discovery operation on Host 2 via the network interface. vPDI also provides a generic handler for all the virtual PCI devices and redirects all expected operations to the corresponding devices available on Host 2 via the vNetwork Manager. The vPDI component works in tandem with the vResource Manager and vConfig-Space Manager to ascertain the availability of required device resources as well as configuration space and memory mapped I/O handling for virtual devices.

vResource Manager:—On both Host 1 as well Host 2, vResource Manager (vRM) is responsible for virtual PCI device resource management which includes monitoring as well as synchronization of PCI bus and device resources and their interaction with vPCI Device Interface. Additionally on Host 1, vRM interacts with the vMemory Mapped I/O Manager for the memory mapped I/O associated with the virtual devices. On Host 2, this component works mainly to identify and isolate the local operations from those requested over the network by Host 1. This includes segregating the local operations from the I/O requests initiated by Host 1 remotely over the network. The same kind of trap behavior is also utilized for the output of the performed operation. For the local I/O on Host 2, the result of the execution is limited locally whereas for a remotely initiated I/O operation from Host 1, the result of the execution is to isolate from the local kernel on Host 2. This behavior is similar to the “trap and emulate” behavior implemented by a typical hypervisor where resources are virtualized locally.

vConfig-Space Manager:—The vConfig-Space Manger (vCM) component interacts closely with the vNetwork Manager. In the initialization process of the virtual devices, the vCM component works in tandem with vMemory Mapped I/O Manager to ascertain valid allocation of memory mapped I/O resources. The vCM component mainly handles the initialization as well as interaction operations for the config-space of PCI devices on both sides. On Host 1, this creates a virtual configuration space which emulates the behavior of a normal configuration space of PCI device. This configuration space exists in central host memory instead of as an R/W memory location on the PCI device itself. On Host 2, the vCM scans and then transfers a complete image of the existing PCI I/O hierarchy from the root port down through the individual end-points via vNetwork Manager. This transferred image of the Host 2 PCI I/O hierarchy is initialized on Host-1 as the virtual PCI I/O hierarchy.

vMemoryMapped I/O Manager:—The vMemoryMapped I/O Manager (vMM) component is responsible for initialization and handling of the memory map for virtual PCI devices. The need for such a mapping arises from the fact that certain device resources as well as configuration information for the device on Host 1 and Host 2 may overlap. In such a scenario, in order to avoid any conflict due to overlapping resources, this component maps all the remote device information subject to the availability of resources on Host 1 and also informs the vRM component.

vNetwork Manager: The vNetwork Manager(vNM) is a network interface which facilitates communication between Host 1 and Host 2. This communication includes exchange of PCI resources and PCI operations via the network. During the initialization process, the entire collective I/O Hierarchy domain configuration is sent from Host 2 to Host 1, rather than just the configuration information associated with an individual device. This complete information allows creation of the virtual hierarchy on Host 1.

Hypervisor Implementation—In an approach very similar to the kernel space implementation, the invention is realized in a hypervisor (also referred to as a Virtual Machine Manager or “VMM”), as a Soft i-PCI “stub”. See FIG. 14, Hypervisor Implementation. In this implementation, the software stack remains essentially the same as with the Kernel Space Implementation, it is just relocated to the Hypervisor. The Host 1 software discovers and initializes the remotely available PCI architecture of Host 2 and provides the handover to the hypervisor in a similar fashion as with the Kernel Space implementation described in the previous section.

### IV. Virtualization Pipe Bridge

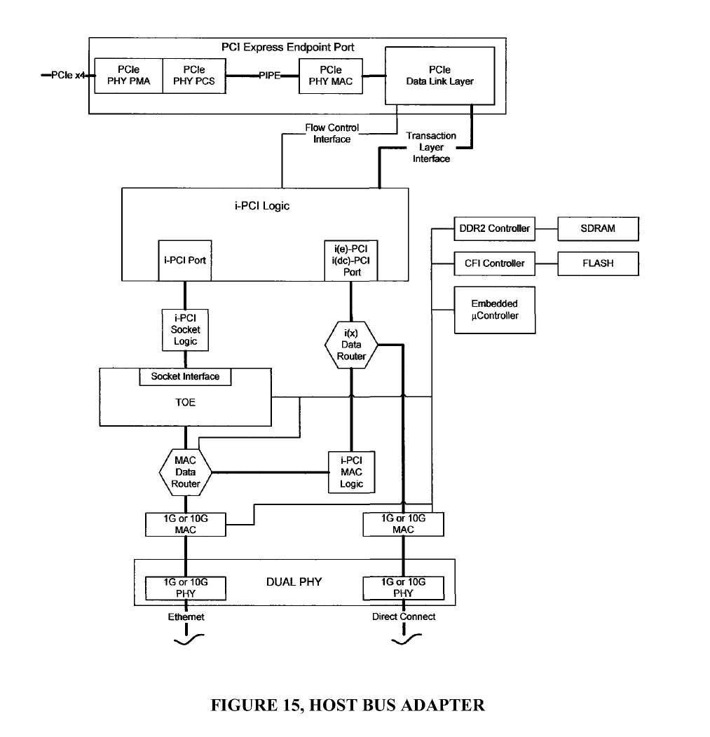

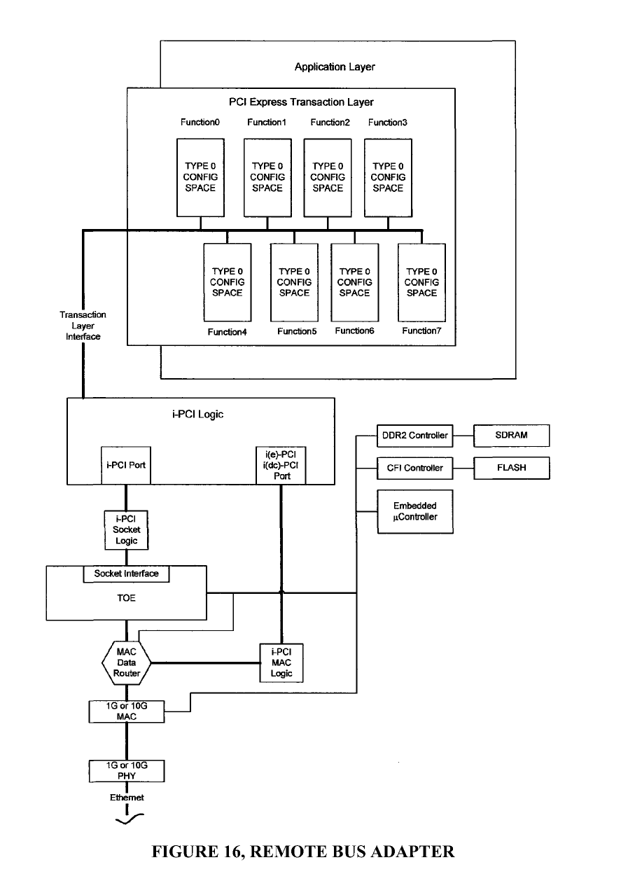

A related hardware/software system and method specifically for virtualization of an Endpoint function via the Internet and LANs is described in U.S. patent application Ser. 12/653,785. The system described therein achieves technical advantages in that it allows the use of low-complexity, low-cost PCI Express Endpoint Type 0 cores or custom logic for relatively simple virtualization applications. The system combines two physically separate assemblies in such a way that they appear to the host system as one local multifunctional PCI Express Endpoint device. One assembly (Host Bus Adapter) is located locally at the host computer and one assembly (Remote Bus Adapter) is located remotely. Separately they each implement a subset of a full Endpoint design. Together they create the appearance to the host operating system, drivers, and applications as a complete and normal local multifunctional PCI Express device. In actuality the device transaction layer and application layer are not located locally but rather they are located remotely at some access point on a network. Together the local assembly and the remote assembly appear to the host system as though they are a single multifunction Endpoint local device. FIG. 15 shows a block diagram of the Host Bus Adapter as disclosed by Ser. No. 12/653,785. FIG. 16 shows a block diagram of the Remote Bus Adapter as disclosed by Ser. No. 12/653,785.

One aspect of the invention provides an implementation advantage in virtualized extended systems applications, as it reduces complexity by allowing the interface to the i-PCI logic to be implemented at an industry standard interface. As disclosed by Ser. No. 12/653,785, the interface to the i-PCI logic is nonstandard and proprietary, per IP core or ASIC implementation.

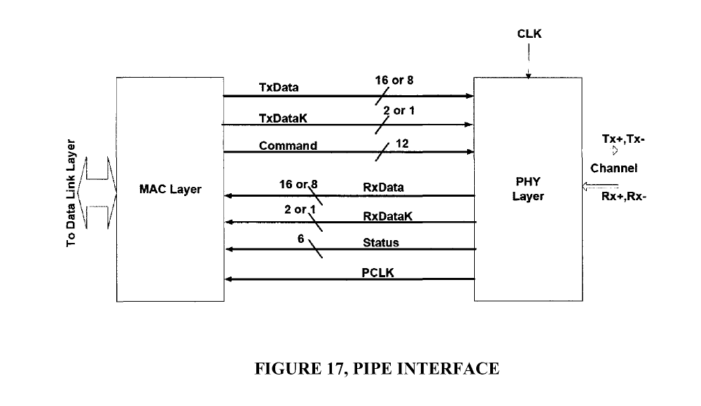

The invention is an improved method for virtualization utilizing the PHY Interface for the PCI Express Architecture (PIPE) to connect to the i-PCI Logic, thus eliminating the non-industry standard proprietary combination Transaction Layer and Flow Control interface as shown in FIG. 15. In contrast, the signals for the PIPE interface are standardized and defined by “PHY Interface for PCI Express Architecture”, published by Intel Corporation. See FIG. 17, PIPE Interface.

The PCIe PHY PCA and PCS functionality are commonly provided as PCIe “hard IP” transceiver blocks for FPGAs and ASICs. Thus, the PIPE interface is readily available and accessible to the implementer without requiring purchase or design of additional IP cores.

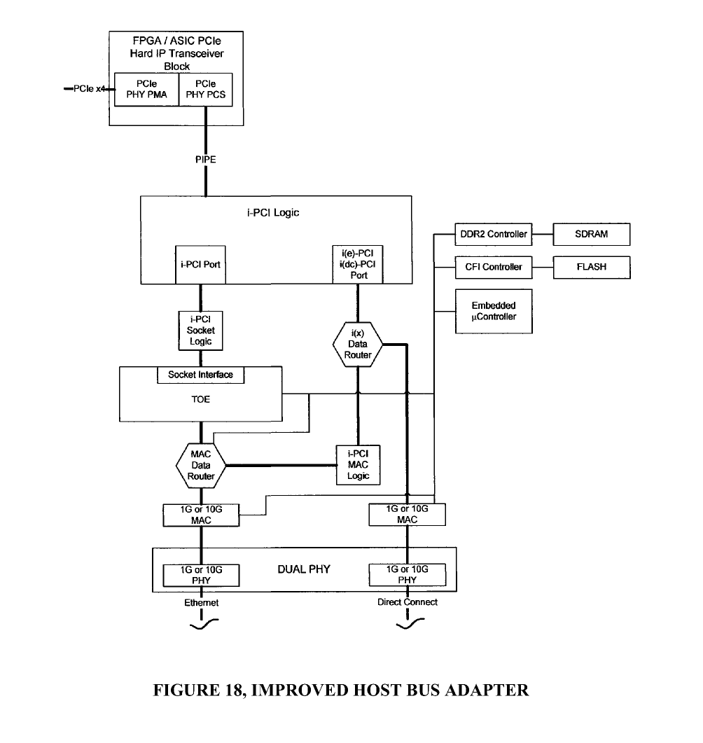

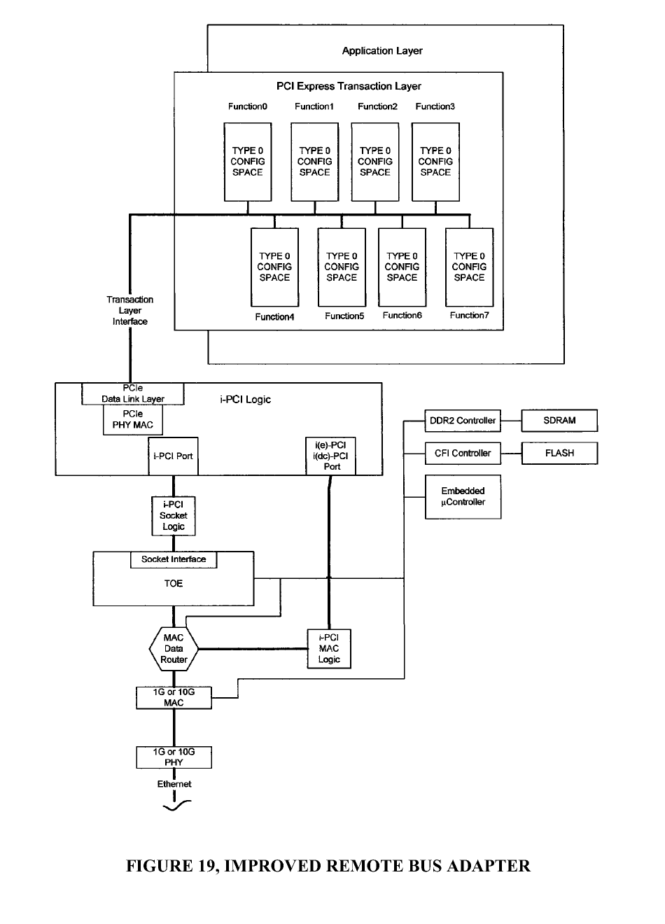

The invention allows virtualization to be based on industry standards, thus facilitating and easing implementation. The virtualization then allows the PCIe PHY and data link layers to be relocated to the Remote Bus Adapter and incorporated in the i-PCI Logic, thus shielding the implementer from proprietary interfaces. The improved Host Bus Adapter and Remote Bus Adapter utilizing the invention is shown in FIG. 18 and FIG. 19.

### V. I/O Virtualization Utilizing Restricted Bandwith Infrastructure Networks

Restricted Bandwidth Infrastructure Networks—Various installed infrastructure wiring is coming to the forefront in network communications as an alternative physical layer transport to the typical CAT-x Ethernet cable. The attraction of this approach is that it allows the use of the existing electrical wiring running through a building, eliminating the need for construction activities required to retro-fit the building with dedicated CAT-x network cable. In particular, Power Line Communication (PLC) has gained popularity. PLC uses the electrical power wiring with a home or office. PLC may be used to establish a network to interconnect computers, peripherals. The most widely deployed power line network to date is HomePlug AVdefined by the HomePlug Powerline Alliance industry group. Global industry standards organizations have recently taken up this technology and are developing two industry standards as follows:

IEEE 1901: This standard is being developed by the IEEE Communications Society. The focus is on defining standards for high-speed (greater than 100 Mbps) communication through AC electric power lines.

ITU-T G.hn: This standard is being developed by the International Telecommunication Union's Telecommunication standardization sector. The standard defines the physical layer for home-wired networks, with the overriding goal of unifying the connectivity of digital content and media devices by providing a wired home network over residential power line, telephone, and coaxial.

Although these two standards organizations are approaching the problem from somewhat different perspectives, they share much of the same core functionality and technology. For example, both standards provide contention-based channel access for best effort QoS and contention-free QoS-guaranteed capabilities. Tables 1-3 contrast and compare these two standards.

TABLE 1
IEEE 1901 vs. ITU-T G.hn - Features and Associated Technology

| | IEEE 1901 | | |
|---|---|---|---|
| Feature and Technology | FFT-PHY | Wavelet-PHY | ITU-T G.hn |
| Channel Access | | | |
| Fundamental Technology | CSMA/CA | CSMA/CA | TDMA, CSMA/CA |
| Contention-based Scheme | CSMA/CA | CSMA/CA | CSMA/CA |
| RTS/CTS Reservation | Optional | Optional | Optional |
| Access Priorities | 4 | 8 | 4 |
| Virtual Carrier Sensing | Yes | Yes | Yes |
| Contention-free Scheme | TDMA | TDMA | TDMA |
| Persistent Access | Yes | Yes | Yes |
| Access Administration | Beacon Based | Beacon Based | MAP Based |
| Quality of Service | Supported | Supported | Supported |
| Security | | | |
| Security Framework | DSNA/RSNA | PSNA/RSNA | AKM |
| Encryption Protocol | CCMP | CCMP | CCMP |
| Burst Mode Operation | Uni-/bi-directional | Not supported | Bi-directional |
| Addressing Scheme | | | |
| Modes | Uni-, Multi-, and Broadcast | Uni-, Multi-, and Broadcast | Uni-, Multi-, and Broadcast |
| Space (per domain) | 8-bit | 8-bit | 8-bit |
| Framing | | | |
| Aggregation | Supported | Supported | Supported |
| Fragmentation and Reassembly | | | |

TABLE 2
IEEE 1901 vs. ITU-T G.hn - Applications Comparison

| | ITU-T | IEEE |
|---|---|---|
| High-rate Broadband Access | No | 1901 |
| High-rate Broadband In-home | G.hn (50/100 MHz) | 1901 |
| Low-rate Broadband In-home | G.hn (25 MHz) | No |
| Low-rate, Low-frequency | G.hnem (500 kHz) | 1901 (500 kHz) |
| Narrowband | | |

TABLE 3
IEEE 1901 vs. ITU-T G.hn - Layers and Associated Standards

| | ITU-T PLC | IEEE PLC |
|---|---|---|
| PHY Layer | Single (OFDM) | Dual (OFDM/Wavelet) |
| MAC Layer | Single (OFDM) | Dual (OFDM/Wavelet) |
| Target Medium | Coax, Phone line, Power line | Power line |
| Standard Docs. | G.hn (MAC-G.9961) | IEEE 1901 |
| | G.hn (PHY-G.9960) | (MAC/PHY/Coexistence) |
| | G.cx (Coexistence-G.9972) | |
| | G.hnem (Narrowband) | |

One aspect of the invention is a method and apparatus for virtualization of Host I/O via restricted bandwidth infrastructure networks where IEEE 1901 and ITU-T G.hn are the preferred standards. The invention incorporates a Medium Access Control (MAC) for power line communications into a Host Bus Adapter and Remote Bus Adapter that collectively enables I/O virtualization, despite relatively limited bandwidth. Data throughput for IEEE 1901 approaches 1 Gbps at the PHY layer and 600 Mbps at the MAC layer. This level of throughput is within a range that makes I/O virtualization feasible, in consideration of the invention. The invention advantageously interfaces to a Class System Handler as defined in U.S. patent application Ser. No. 12/587,788 to provide a superior mapping than otherwise possible.

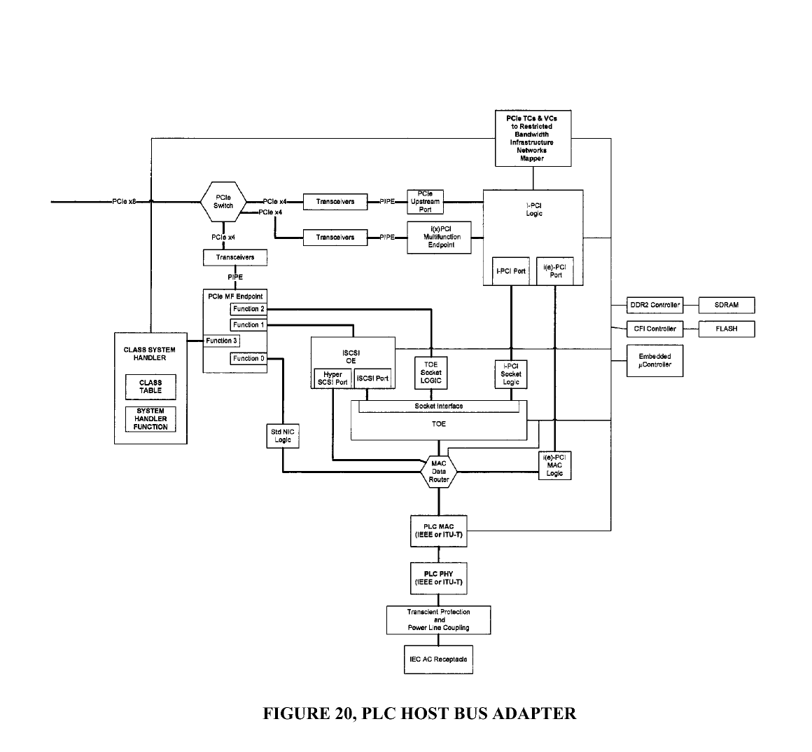

The invention implements a Class System Handler, in one preferred implementation, as a PCIe function and couples it to a PCIe TCs and VCs to a Restricted Bandwidth Infrastructure Networks Mapper, “Mapper”. The Mapper includes a configuration interface to the MAC, allowing determination of the MAC type, to complete the apparatus. Timeout and latency mitigation techniques disclosed in U.S. Pat. No. 7,734,859 are incorporated within the i-PCI logic. FIG. 20, PLC Host Bus Adapter shows a block diagram of the resultant apparatus.

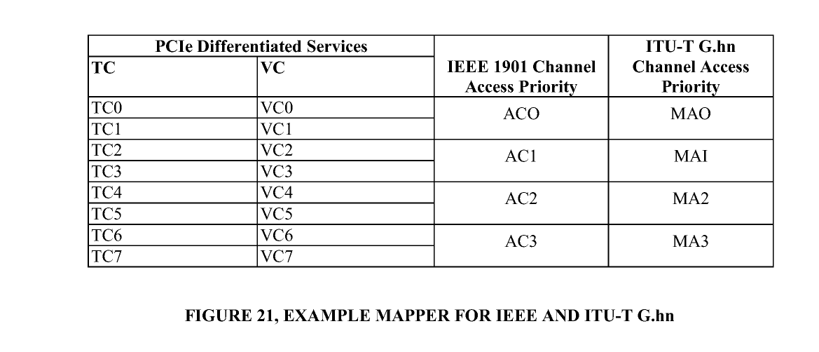

Since the PLC standards implement QoS, this can be utilized in I/O virtualization by mapping to appropriate PCIe QoS differentiated services. FIG. 21, Example Mapper for IEEE 1901 and ITU-T G.hn, provides an illustrative example of the internal mapping table forming the basis of the PCIe TCs & VCs to Restricted Bandwidth Infrastructure Networks Mapper. This Mapper block is coupled to the i-PCI Logic block enabling effective referencing and processing of ingress and egress PCIe TLPs.

FIG. 21 is a simplified example Mapper and is meant to be illustrative of the concept. The tight coupling of the Mapper and the Class Table contained within the Class System Handler ensures that QoS information associated with the Mapper is readily available for use in classification such that application performance is predictable and manageable, thus optimizing user experience.

The end result is an effective I/O virtualization via a restricted bandwidth infrastructure network.

### VI. Two-Part Direct Memory Access Checksum

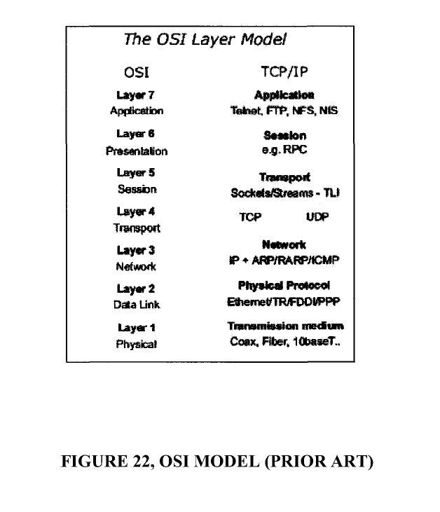

In network communications, data transfers are accomplished through passing a transaction from application layer to application layer via a network protocol software stack, ideally structured in accordance with the standard OSI model. A widely used network protocol stack is TCP/IP. See FIG. 22, OSI model, illustrating the OSI model layers and the TCP/IP corresponding protocols.

TCP/IP is popular for providing a reliable transmission between hosts and servers. Reliability is achieved through checksum and retransmission. TCP provides end-to-end error detection from the original source to the ultimate destination across the Internet. The TCP header includes a field that contains the 16-bit checksum. The sending device's TCP on the transmitting end of the connection receives data from an application, calculates the checksum, and places it in the TCP segment checksum field. To compute the checksum, TCP software adds a pseudo header to the segment, adds enough zeros to pad the segment to a multiple of 16 bits, then performs a 16-bit checksum on the whole thing. Checksum is widely known to be one of the most time consuming and computationally intensive parts of the whole TCP/IP processing.

A TCP/IP Offload Engine (TOE) is a processing technology which offloads the TCP/IP protocol processing from the host CPU to the network interface, thus freeing up the CPU for other tasks. TOE implementations are often used in high-throughput network applications with data rates in the Gbps range. TOE implementations are also used in embedded applications to offload the microcontroller which can become overburdened with executing the TCP/IP protocol, leaving little CPU cycles for typical command & control tasks.

In the current state of the art, the checksum on the transmit side of a TOE is implemented as a separate hardware logic module which calculates a 16-bit TCP checksum on each packet following assembly of the packet. In the current state of the art, the TOE checksum calculation is performed sequentially and is a significant contributor to the latency of packet processing, limiting the overall TOE performance.

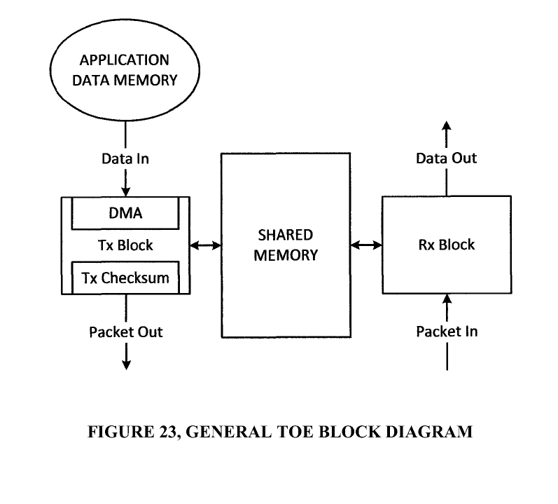

The general high-level block diagram for a TOE is shown in FIG. 23. The major processing blocks are the transmit (Tx) and receive (Rx) blocks.

The checksum is calculated on the Tx side for every output packet. The checksum is calculated as: (Tx Checksum)=(header checksum)+(data checksum). In the current state of the art, this calculation is performed by logic in the Tx Block as a single step in the processing sequence after all information for the packet is available and assembled. The data checksum portion of the calculation typically composes 95% to 98% of the total overhead associated with the Tx Checksum computation.

The invention is a new high throughput “Two-Part” checksum solution, implemented via a first “Tx Data Checksum” module and a second “Tx Header Checksum” module. This solution may be advantageously applied on the transmit side of a TCP/IP offload engine. The invention results in 20% to 40% performance improvement for a pipelined TOE architecture. The invention advantageously performs the checksum calculation as a unique and efficient two-part solution as opposed to the current state-of-the-art monolithic calculation logic.

In typical data transfers, the Data In (as shown in FIG. 23) consists of a continuous stream of bytes sourced by the Application Data Memory and accessed via Direct Memory Access (DMA) transactions internal to the Tx Block of the TOE. The DMA in this case takes Data In from the Application Data Memory and passes it to the internal modules of the Tx Block to create a packet.

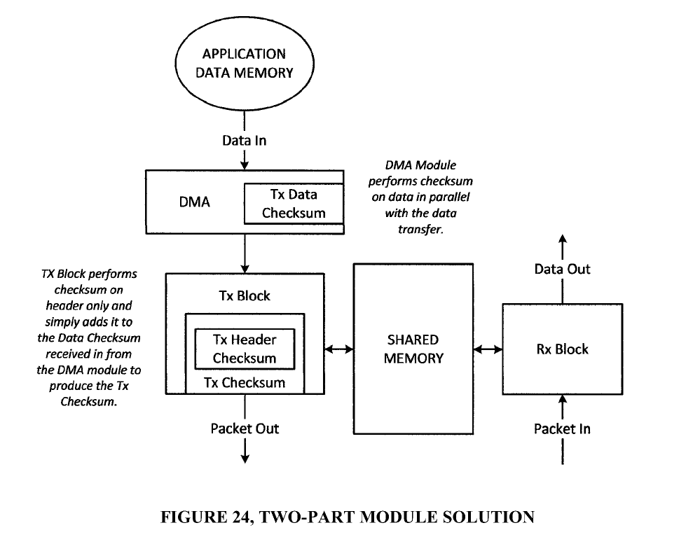

The fact that the DMA accesses or ‘touches’ each byte of data can be advantageously exploited to calculate the checksum “on-the-fly” during DMA access of the data. In the invention, the DMA is separated out as its own block and in addition to accomplishing the transfer is configured to simultaneously calculate the data checksum, via the Tx Data Checksum module, in a parallel operation. The data checksum is then passed to the Tx Block along with the associated Data In. In the Tx Block, the header checksum is calculated in the second module that's a component of the Tx Block. The header checksum is simply added to the data checksum passed in by the DMA to produce the complete Tx Checksum. The Two-Part module solution is shown in FIG. 24.

### VII. Virtual Desktop Accelerator

Open Blade Servers—A problem with certain blade server architectures is PCI Express is not easily accessible, thus expansion is awkward, difficult, or costly. In such an architecture the chassis backplane does not route PCI or PCI Express to the I/O module bays. An example of this type of architecture is the open blade server platforms supported by the Blade.org developer community: http://www.blade.org/aboutblade.cfm

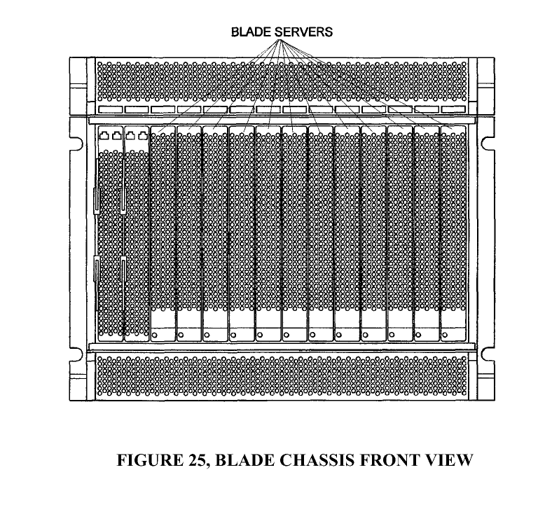

FIG. 25 shows the front view of a typical open blade chassis with multiple blades installed. Each blade is plugged into a backplane that routes 1 Gbps Ethernet across a standard fabric and optionally Fibre Channel, Infiniband, or 10 Gbs Ethernet across a high-speed fabric that interconnects the blade slots and the I/O bays.

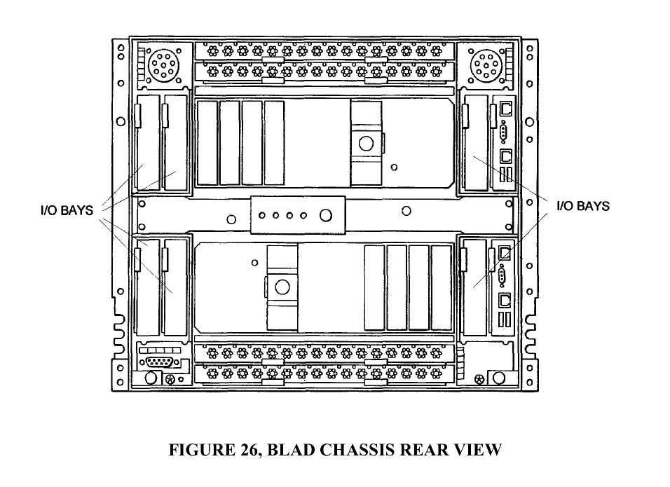

FIG. 26 shows the rear view and the locations of the I/O bays with unspecified I/O modules installed. A primary advantage with blades over traditional rack mount servers is they allow very high-density installations. They are also optimized for networking and Storage Area Network (SAN) interfacing. However, there is a drawback inherent with blade architectures such as that supported by the blade.org community. Even though the blades themselves are PCI-based architectures, the chassis back plane does not route PCI or PCI Express to the I/O module bays. Since PCI and PCI Express are not routed on the back plane, the only way to add standard PCI functions is via an expansion unit that takes up a valuable blade slot. The expansion unit in this case adds only two card slots and there is no provision for standard PCI Express adapters. It is an inflexible expansion, as it is physically connected and dedicated to a single blade.

Virtual Desktop—The term Virtual Desktop refers to methods to remote a user's PC desktop, hosted on a server, over a LAN or IP network to a client at the users work location. Typically this client is a reduced “limited” functionality terminal or “thin client”, rather than a full PC. Limited functionality typically includes video, USB I/O and audio. One of the existing technologies for implementing Virtual Desktops is PCoIP. PCoIP uses networking and encoding/decoding technology between a server host (typically located in a data center) and a “portal” located at the thin client. Using a PCoIP connection, a user can operate the PC desktop, via the thin client, and use the peripherals as if the PC were local.

A PCoIP system consists of a Host Processing Module located at the host server and a Portal Processing Module located at the user thin client. The Host Processing Module encodes the video stream and compresses it, combining it with audio and USB traffic and then sends/receives via the network connection to the Portal Processing Module. The Portal Processing Module decompresses the incoming data and delivers the video, audio, and USB traffic. The Portal Module also combines audio and USB peripheral data for sending back to the Host.

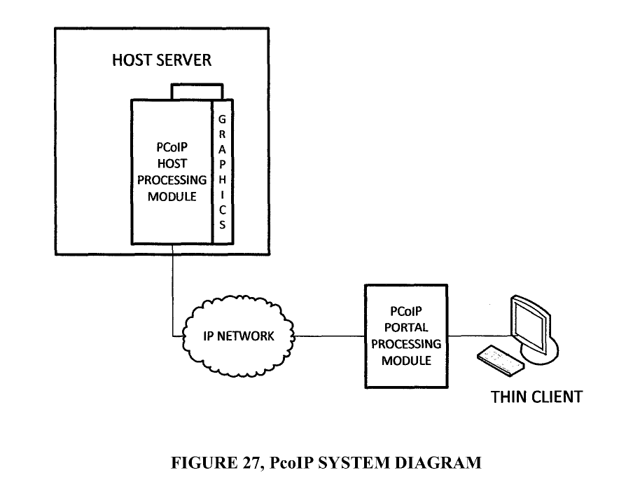

The PCoIP processing modules may be implemented as hardware-based solutions or as software-based solutions. In the hardware solution, the Host Processing Module is paired with a graphics card, which handles the video processing. The tradeoff between the two solutions is one of performance, as well as consumption of server/thin client CPU resources. The hardware solution, essentially an offload, minimizes CPU utilization and improves performance. A diagram of the PCoIP solution using a conventional (non-blade) server is shown in FIG. 27.

One aspect of the invention is a method and apparatus for improving virtual desktop performance. In particular, it achieves high performance for Blade Center applications, where PCI Express is not readily accessible, thus enabling the use of hardware-based offload for PCoIP.

The method and apparatus consists of a Low Latency High Speed Adapter Card, A Low Latency I/O Module, and an Accelerator Module. The invention utilizes virtualization of the PCI I/O system of the individual blade servers, via 10 Gigabit Attachment Unit Interface (XAUI) routing across the backplane high-speed fabric of a blade server chassis. The invention leverages i-PCI as the virtualization protocol. The Accelerator Module is connected to the server chassis via the direct connect version of i-PCI, i(dc)-PCI, or the Ethernet version, i(e)-PCI, as a low latency high performance link. In preferred implementation, the link may be via 10 GBASE-SR (optical) or 10 GBASE-T (copper).

A major contributor to the latency in virtualization solutions that utilize 802.3an (10 GBASE-T) is the introduced latency associated with the error correcting “Low-Density Parity-Check Code” (LDPC). LDPC is used to get the large amounts of data across the limited bandwidth of the relatively noisy copper twisted pair CAT 6 cable. LDPC requires a block of data to be read into the transmitter PHY where the LPDC is performed and then sent across the cable. The reverse happens on the receiving side. The total end-to-end latency associated with the coding is specified as 2.6 microseconds. This introduced latency can be a serious barrier to deploying latency sensitive applications via virtualization, requiring special latency and timeout mitigation techniques that add complexity to the virtualization system.

With the invention, the latency problem can be avoided across the backplane. Instead of running 10 GBASE-T across the backplane as disclosed in U.S. patent application Ser. No. 12/587,780, XAUI is run across the backplane, to a unique Low Latency I/O 10 Gbps Switch Module with a XAUI interface to the backplane. These are not concepts envisioned by the Open Blade standard, so it is not obvious based on the current state of the art. Since there is no PHY associated with this link across the backplane, the associated latency is advantageously eliminated.

The low latency solution is then extended external to the Blade Chassis to the Accelerator Module containing the Host Processing Module paired with a Graphics Card and a Solid State Disk (SSD), all seen by the Blade Server as memory-mapped I/O, via I/O virtualization. The SSD serves as high-speed/high-performance storage for the PC desktop. The link to the Accelerator Module utilizes 802.3ak twin-axial or 802.3ae fiber optic links (typically 10 GBASE- SR or LR) that avoid the LDPC associated with 10 GBASE-T.

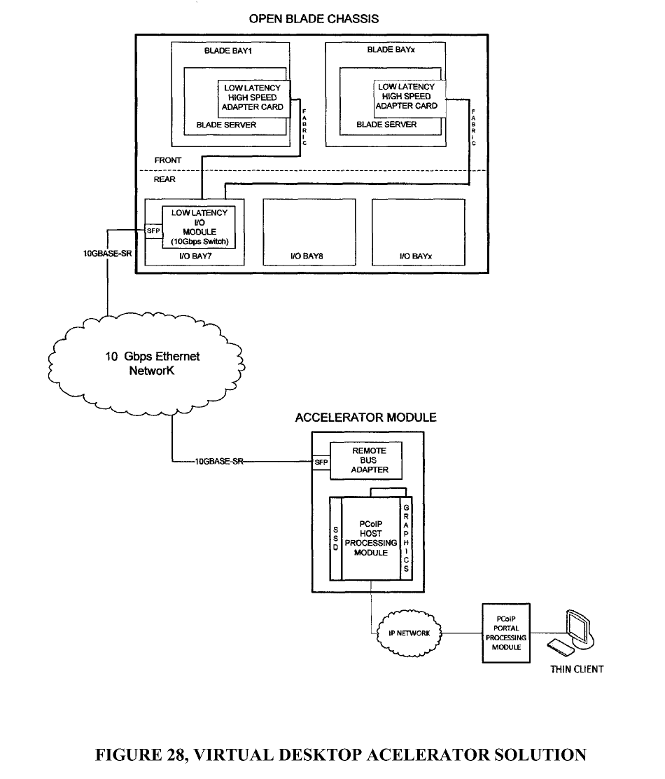

FIG. 28 depicts a block diagram of the overall high-performance Virtual Desktop Accelerator solution.

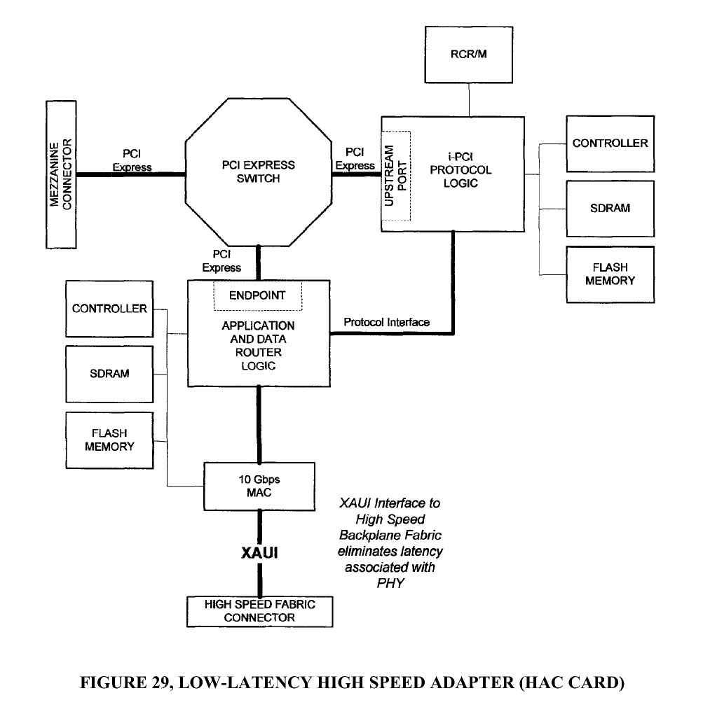

FIG. 29 shows the major functional blocks of a Low-Latency High Speed Adapter (HAC) card.

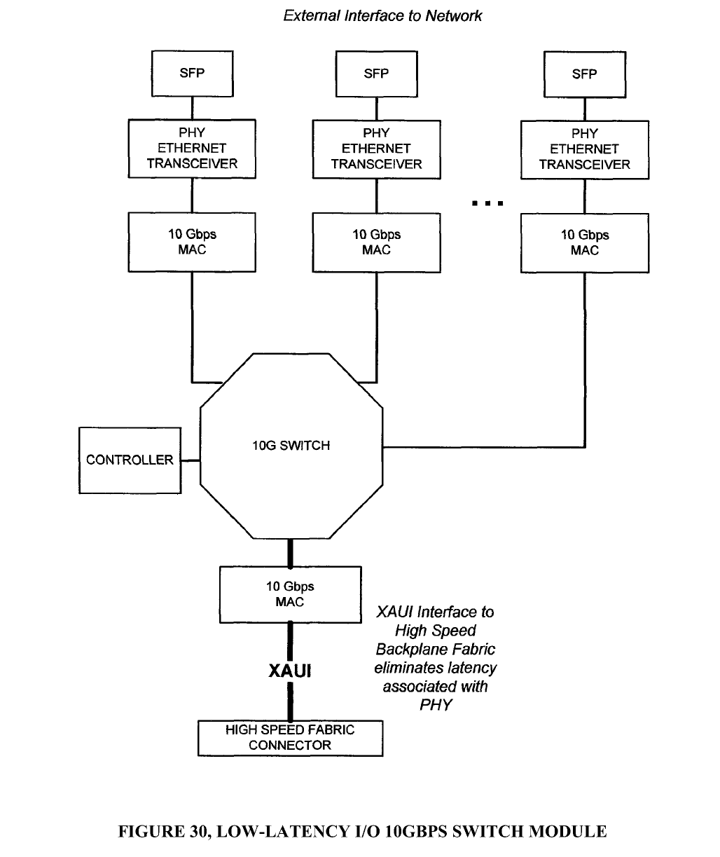

FIG. 30 shows the major functional blocks of a Low-Latency I/O 10 Gbps Switch Module.

The end result is an unprecedented high-performance Virtual Desktop Accelerator.

### VIII. Remote Virtualized Desktop Accelerator Pool

Soft i-PCI—Soft i-PCI, is described in U.S. patent application Ser. No. 12/655,135. Soft i-PCI pertains to extending the PCI System of a host computer via software-centric virtualization. The invention utilizes 1 Gbps-10 Gbps or greater connectivity via the host's existing LAN Network Interface Card (NIC) along with unique software to form the virtualization solution.

Soft i-PCI enables i-PCI in those implementations where an i-PCI Host Bus Adapter as described in U.S. Pat. No. 7,734,859, may not be desirable or feasible.

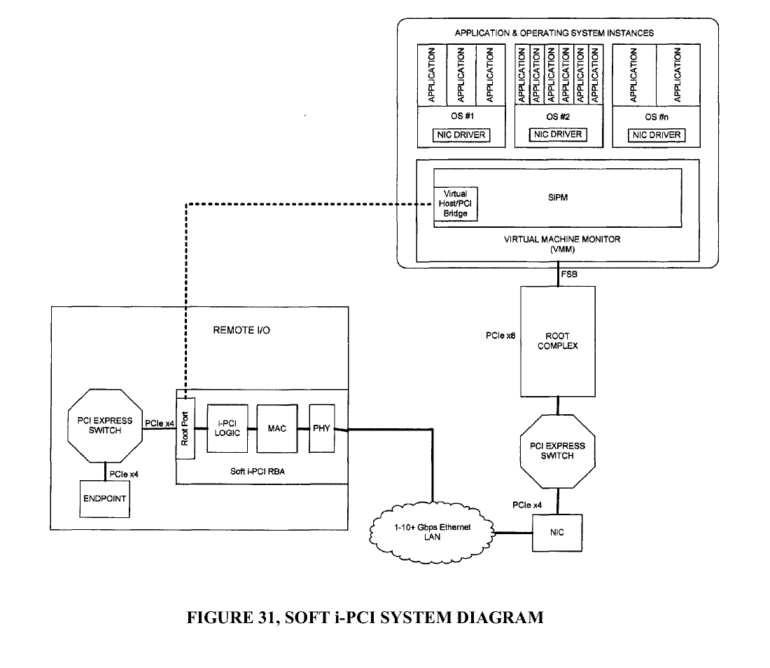

Soft i-PCI enables creation of one or more instances of virtual I/O hierarchies through software means, such that it appears to host CPU and Operating Systems that these hierarchies are physically present within the local host system, when they are in fact not. In actuality a given virtual hierarchy is a partial software construct or emulation, with the physical I/O located remote, connected to the host via the host system's Network Interface Card (NIC) and a LAN, as shown in FIG. 31.

Virtual Desktop—The term Virtual Desktop refers to methods to remote a user's PC desktop, hosted on a server, over a LAN or IP network to a client at the users work location. Typically this client is a reduced “limited” functionality terminal or “thin client”, rather than a full PC. Limited functionality typically includes video, USB I/O and audio. One of the existing technologies for implementing Virtual Desktops is PCoIP. PCoIP uses networking and encoding/decoding technology between a server host (typically located in a data center) and a “portal” located at the thin client. Using a PCoIP connection, a user can operate the PC desktop, via the thin client, and use the peripherals as if the PC were local.

A PCoIP system consists of a Host Processing Module located at the host server and a Portal Processing Module located at the user thin client. The Host Processing Module encodes the video stream and compresses it, combining it with audio and USB traffic and then sends/receives via the network connection to the Portal Processing Module. The Portal Processing Module decompresses the incoming data and delivers the video, audio, and USB traffic. The Portal Module also combines audio and USB peripheral data for sending back to the Host.

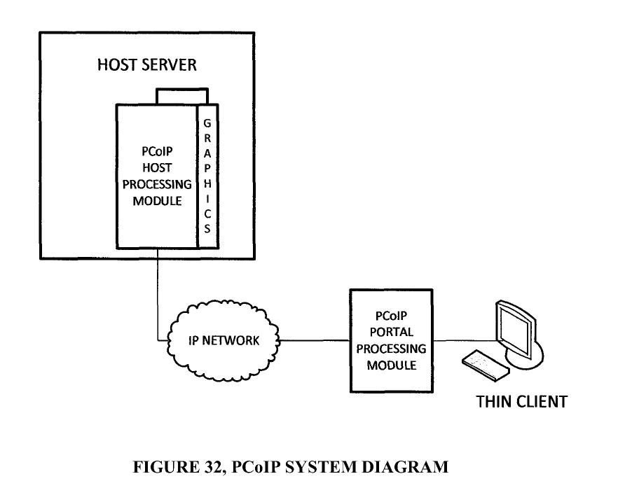

The PCoIP processing modules may be implemented as hardware-based solutions or as software-based solutions. In the hardware solution, the Host Processing Module is paired with a graphics card, which handles the video processing. The tradeoff between the two solutions is one of performance, as well as consumption of server/thin client CPU resources. The hardware solution, essentially an offload, minimizes CPU utilization and improves performance. A diagram of the PCoIP solution using a conventional (non-blade) server is shown in FIG. 32.

A problem with Virtual desktops is a Host Processing Module (and associated Graphics processor) are typically “married” to a single thin client and limited to one Host Processing Module per Host. The invention is a method and apparatus for allowing a pool of Host Processing Modules to be virtualized and established, remote from the Host such that the Host Processing Modules may then be flexibly assigned/reassigned, as needed, to a pool of Thin Clients. Associations are established between individual thin clients and a particular Virtual Machine running in the Host. The invention leverages i-PCI and soft i-PCI in particular, to establish the pools of remote virtualized Host Processing Modules and Thin Clients. An enhanced capability Virtual Host/PCI Bridge provides the required isolation and management necessary, within the hypervisor, to facilitate the association between a given Host Processing Module and a Virtual Machine assigned to a user.

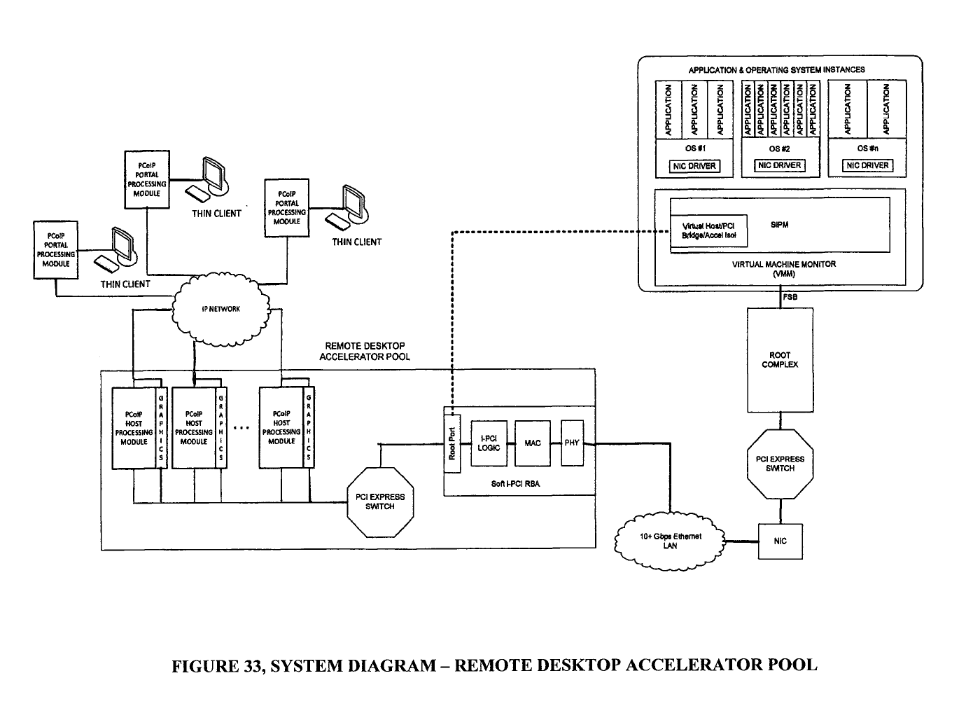

FIG. 33 provides an illustration of the invention.

### IX. Memory-Mapped Thin Client

Virtual Desktop—The term Virtual Desktop refers to methods to remote a user's PC desktop, hosted on a server, over a LAN or IP network to a client at the users work location. Typically this client is a reduced “limited” functionality terminal or “thin client”, rather than a full PC. Limited functionality typically includes video, USB I/O and audio. One of the existing technologies for implementing Virtual Desktops is PCoIP. PCoIP uses networking and encoding/decoding technology between a server host (typically located in a data center) and a “portal” located at the thin client. Using a PCoIP connection, a user can operate the PC desktop, via the thin client, and use the peripherals as if the PC were local.

A PCoIP system consists of a Host Processing Module located at the host server and a Portal Processing Module located at the user thin client. The Host Processing Module encodes the video stream and compresses it, combining it with audio and USB traffic and then sends/receives via the network connection to the Portal Processing Module. The Portal Processing Module decompresses the incoming data and delivers the video, audio, and USB traffic. The Portal Module also combines audio and USB peripheral data for sending back to the Host.

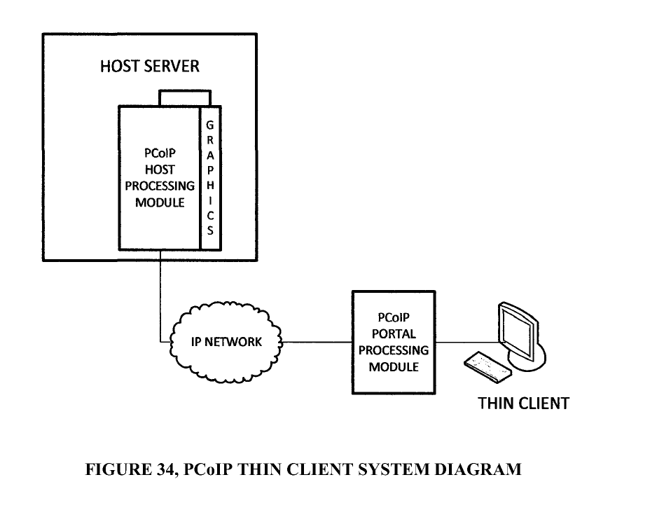

The PCoIP processing modules may be implemented as hardware-based solutions or as software-based solutions. In the hardware solution, the Host Processing Module is paired with a graphics card, which handles the video processing. The tradeoff between the two solutions is one of performance, as well as consumption of server/thin client CPU resources. The hardware solution, essentially an offload, minimizes CPU utilization and improves performance. A diagram of the PCoIP solution using a conventional (non-blade) server is shown in FIG. 34.

One aspect of the invention is an alternative and advantageous method for creation of a thin client, based on i-PCI. In an i-PCI thin client scenario, the PCoIP Host Processing Module is replaced by an i-PCI Host Bus Adapter. The PCoIP Portal Processing Module is replaced by a Remote I/O, where the Remote I/O is configured with any PCIe adapter cards or functions desired to create a unique and more capable thin client.

The i-PCI thin client, since it is a memory-mapped solution, is not limited to just video, audio, and USB as with PCoIP. A major drawback of existing PCoIP thin client solutions is they are in essence a step backward from the end user perspective. A thin client is much less capable, more restrictive and less customizable. These are characteristics that result in user resistance to thin client deployment. With the invention, this resistance may be more readily overcome. An i-PCI thin client gives the end user much more flexibility and capability since the PCI memory-mapped architecture of the Data Center Host is extended out to the user. From a capability perspective, i-PCI is far superior to PCoIP, provided there is at least 10 Gbps Ethernet routed to the thin client. The i-PCI thin client may be populated with Firewire, SCSI, SATA, high-end video editing adapters, data acquisition, industrial controls, development boards, etc.—an almost unlimited selection of capability, while still retaining the key characteristics of a thin client—that is the CPU, OS, drivers, and application software all remain centrally located at the data center Host. The Host may have multiple virtual machines supporting multiple thin clients, all with customized I/O and peripherals.

The invention, in one preferred implementation illustrative of the concept, targets high-end users demanding top performance (such as might be the case in an engineering firm, game developer firm, securities firm). In this scenario, virtualization of the PCI I/O system of individual blade servers, is accomplished via 10 Gigabit Attachment Unit Interface (XAUI) routing across the backplane high-speed fabric of a blade server chassis. The invention leverages i-PCI as the virtualization protocol.

A major contributor to the latency in virtualization solutions that utilize 802.3an (10 GBASE-T) is the introduced latency associated with the error correcting “Low-Density Parity-Check Code” (LDPC). LDPC is used to get the large amounts of data across the limited bandwidth of the relatively noisy copper twisted pair CAT 6 cable. LDPC requires a block of data to be read into the transmitter PHY where the LPDC is performed and then sent across the cable. The reverse happens on the receiving side. The total end-to-end latency associated with the coding is specified as 2.6 microseconds. This introduced latency can be a serious barrier to deploying latency sensitive applications via virtualization, requiring special latency and timeout mitigation techniques that add complexity to the virtualization system.

With the preferred implementation, the latency problem can be avoided across the backplane. Instead of running 10 GBASE-T across the backplane as disclosed in U.S. patent application Ser. 12/587,780, XAUI is run across the backplane, to a unique Low Latency I/O 10 Gbps Switch Module with a XAUI interface to the backplane. Since there is no PHY associated with this link across the backplane, the associated latency is advantageously eliminated.

The low latency solution may optionally be extended external to the Blade chassis to the thin client containing PCIe adapter cards, utilizing 802.3ak twin-axial or 802.3ae fiber optic links (typically 10 GBASE-SR or LR) that avoid the LDPC associated with 10 GBASE-T.

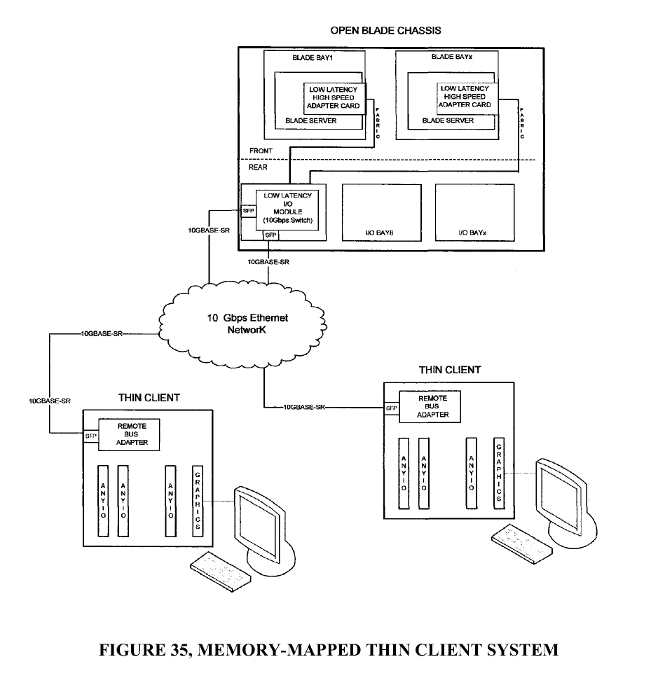

FIG. 35 depicts a block diagram of the overall high performance low-latency memory-mapped thin client solution.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present invention to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

1. An I/O virtualization mechanism configured to enable use of a converged transport, configured to provide means for extension of PCI Express differentiated services via the Internet, LANs, WANs, and WPANs.
